(19) United States
(12) Patent Application Publication
(10) Pub. No.: US 2007/0281627 A1
(43) Pub. Date: Dec. 6, 2007

(54) Media-assisted application for a computing device

(76) Inventors: Prashanth Kadur, Coram, NY (US); James Fagioli, Holtsville, NY (US)

Correspondence Address: FAY KAPLUN & MARCIN, LLP, 15O BROADWAY, SUITE 702, NEW YORK, NY, 10038, US

(21) Appl. No.: 11/447,192

(22) Filed: Jun. 5, 2006

(51) Int. Cl. H04B 1/38

(52) U.S. Cl. 455/73

(57) ABSTRACT

Described is a media-assisted application for a computing device. The device comprises an audio output arrangement, a display screen, a memory and a processor. The display screen displays a plurality of data fields. The memory stores a plurality of audio files. At least one of the audio files is associated with a corresponding one of the data fields. The processor outputs the at least one of the audio files via the audio output arrangement to request an entry of data into the corresponding data field.

### FIELD OF THE INVENTION

The present invention relates generally to media-assisted applications for use on computing devices.

### BACKGROUND

A mobile computing device may be used in a variety of indoor and outdoor environments, e.g., warehouses, retail stores, parking lots, shipping yards, etc. The device generally provides an adjustable user interface that can compensate for environmental conditions in each of the environments. For example, the device may include a display screen with adjustable brightness levels, thus, allowing a user to improve viewability of the display screen in poorly lit environments.

However, simply adjusting the brightness levels may not always improve use of the device. For example, text/images presented on the display screen may be small due to a size of the display screen and may be difficult to read. Also, in bright environments, light may reflect off the display screen generating a glare. Similarly, the view of the display screen may be impacted when the user is required to wear protective eyewear, e.g., when scanning bar codes in a chemical lab. The adjustable user interface provided by the device may not rectify these problems, and efforts by application developers (e.g., increasing font size) provide little benefit. Thus, there is a need to improve the user interface of the device.

### SUMMARY OF THE INVENTION

The present invention relates to a media-assisted application for a computing device. The device comprises an audio output arrangement, a display screen, a memory and a processor. The display screen displays a plurality of data fields. The memory stores a plurality of audio files. At least one of the audio files is associated with a corresponding one of the data fields. The processor outputs the at least one of the audio files via the audio output arrangement to request an entry of data into the corresponding data field.

### DESCRIPTION OF THE DRAWINGS

FIG. 1 shows an exemplary embodiment of a computing device executing a media-assisted application according to the present invention.

FIG. 2 shows an exemplary embodiment of a method according to the present invention.

FIG. 3 shows an exemplary embodiment of a mobile computing unit executing an application according to the present invention.

FIG. 4 shows an exemplary embodiment of a table according to the present invention.

### DETAILED DESCRIPTION

The present invention may be further understood with reference to the following description and the appended drawings, wherein like elements are referred to with the same reference numerals. The present invention describes a media-assisted application for use with a computing device. While the exemplary embodiments are described with reference to an audio-assisted application for use on a mobile computing device, those of skill in the art will understand that the present invention may provide audio (and/or audio-visual) capabilities for applications executed on any type of computing device, stationary and/or mobile. The exemplary embodiments of the present invention also include a software development platform for generating the media-assisted application.

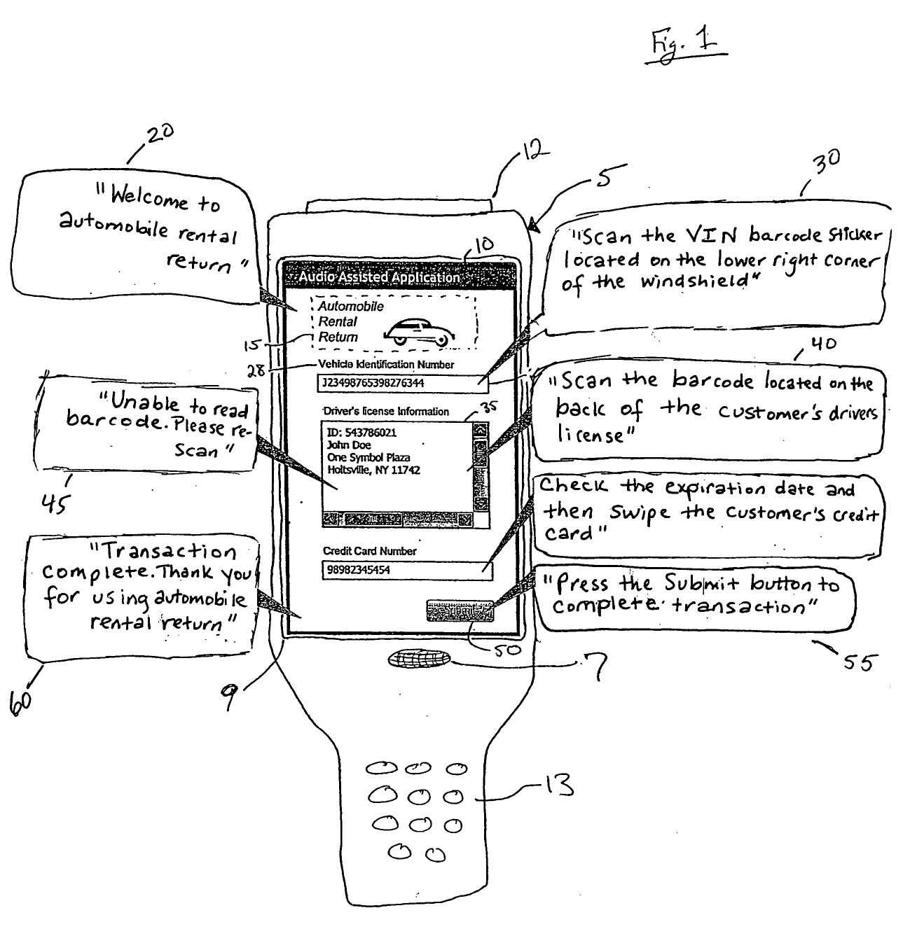

FIG. 1 shows an exemplary embodiment of a computing device (e.g., a mobile computing device 5) executing a media-assisted application according to the present invention. In the exemplary embodiment, the mobile device 5 may be, for example, a laser-based scanner, an imager-based scanner, an RFID reader, a PDA, a mobile phone, a digital camera, a laptop, a tablet computer, a magnetic stripe reader, etc. In embodiments where the computing device is semi-mobile or stationary, it may be a kiosk or a personal computer. The media-assisted application (e.g., an audio-application 10) provides audible output on an audio arrangement (e.g., a speaker 7) related to content of the application shown on a display screen 9 of the mobile device 5. As will be explained further below, the audible output can facilitate a user's interaction with the application by providing instructions, usage tips, guides, help, foreign language translations, etc.

The exemplary embodiments of the application 10 may be useful when the mobile device 5 is used in an environment in which viewing the display screen 9 is or may be difficult. For example, the environment may be a poorly lit environment (e.g., a garage, a warehouse, a shipping yard at night), a bright environment causing glare (e.g., a shipping yard during the day), an industrial environment in which a user is required to wear protective eyewear (e.g., a chemical lab), etc. Content presented on the display screen 9 may also be difficult to view when the content and/or the display screen 9 is less than a predetermined size. The application 10 may also be useful when the mobile device 5 is used by novice/un-trained users (e.g., a self-service modality).

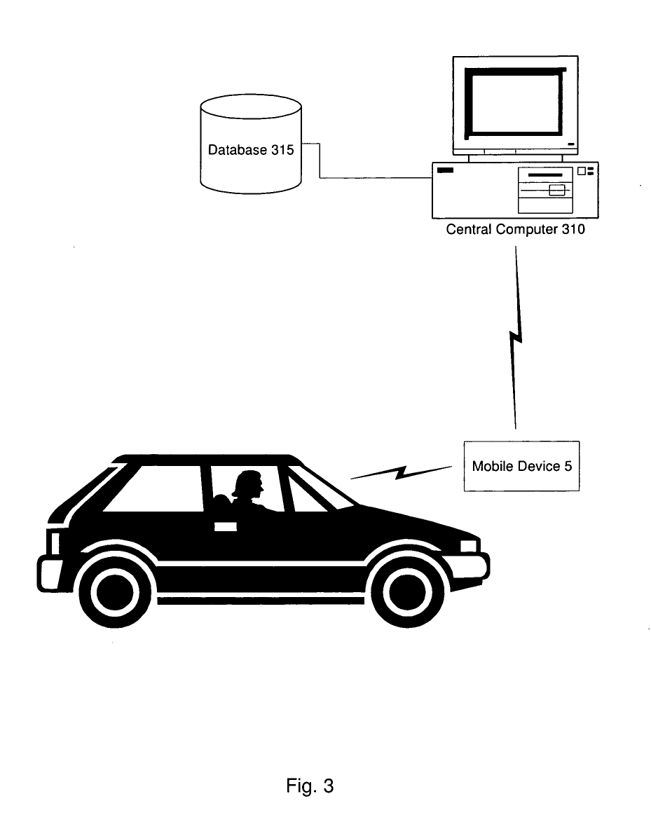

As shown in FIG. 1, the application 10 may include a title field 15 to enhance user-friendliness. That is, the mobile device 5 may be used for a variety of applications, so the title field 15 identifies a type of application that the mobile device 5 is currently executing. In the exemplary embodiment, the title field 15 includes title data (e.g., text and/or an image) indicating that the application 10 is for “Automobile Rental Return.” For example, as shown in FIG. 3, when a customer is returning a rental car, a rental company employee uses the mobile device 5 running the application 10 to retrieve data from the rental car and the customer. The data is wirelessly transmitted (and/or stored in a memory of the mobile device 5) to a central computer 310 which updates a customer account, indicating that the rental car was returned. The central computer 310 may have access to a plurality of customer accounts in a central database 315. Thus, the employee can receive the rental car and present the customer with his bill without the customer having to return to a rental store.

Referring back to the exemplary embodiment shown in FIG. 1, an audio file 20 may be linked to the title field 15. The audio file 20 may be one of a plurality of audio files stored in the memory of the mobile device 5 and which are related to the application 10, as will be explained below. The audio file 20 corresponding to the title field 15 may be played when, for example, a predetermined event occurs. For example, the audio file 20 may be played when the application 10 is launched on the mobile device 5. Thus, when the Automobile Rental Return application is launched, the mobile device 5 outputs (on the speaker 7, to a headset, etc.), “Welcome to automobile rental return.” In other exemplary embodiments, the audio file 20 may be output when, for example, the mobile device 5 switches from a power-save mode to a wake mode.

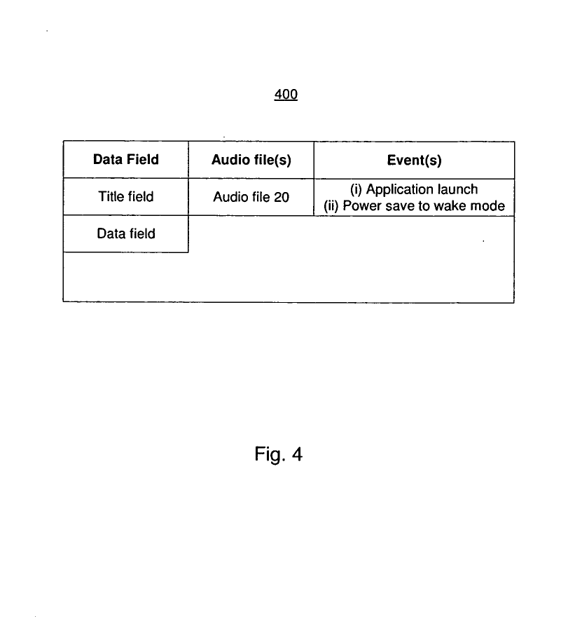

The application 10 may be stored as a table 400 (FIG. 4) which includes fields presented by the application 10, the corresponding audio files linked thereto and the predetermined events which trigger the playback of the corresponding audio files. As shown in FIG. 4, the table 400 includes an entry for the title field 15 which is linked to the audio file 20. The audio file 20 is output when the application 10 is launched, and, when the application 10 is running, when the mobile device 5 switches from the power-save mode to the wake mode.

Referring back to FIG. 1, the application 10 may further include one or more data fields for receiving input data from one or more data input devices integral with or coupled to the mobile device 5. For example, a data field 25 receives the input data corresponding to a Vehicle Identification Number (VIN) from a data input device (e.g., a bar code scanner 12 and/or a keypad 13 on the mobile device 5). That is, the VIN comprises a bar code and its corresponding numerical representation. Thus, the VIN may be entered into the data field 25 by scanning the bar code or typing the numerical representation on the keypad 13. The data field 25, as with other data fields in the application 10, may be associated with a text tag 28 (e.g., “Vehicle Identification Number”). As is known in the art, the text tag 28 is included with the data field 25 so that the user is instructed on what data to input into the data field 25. However, in some environments in which the mobile device 5 is used, it may be difficult to read the text tag 28 and/or view content on the display screen 9. Thus, in the exemplary embodiment, an audio file 30 may be linked with the data field 25. The audio file 30 may instruct the user on how to input the VIN (scanning, typing, etc.) and where it can be found on the rental car.

In the exemplary embodiment, the audio file 30 may be played, in sequence, after the audio file 20 is played. This embodiment may be beneficial when the employee is required to enter the input data in a predetermined sequence. For example, upon receipt of the VIN, the mobile device 5 may wirelessly access the central computer 310 (and/or the database 315) to retrieve data from the customer's account and fill in other data fields automatically with the data. In another exemplary embodiment, the audio file 30 may be played when the data field 25 is highlighted, e.g., when a cursor is placed within the data field 25. This embodiment may be beneficial if there is a delay between hearing the audio file 20 and entering the input data into the mobile device 5. For example, the employee may greet the customer before entering the VIN.

The audio files used in conjunction with the application 10 may further include confirmation and retry audio files. For example, the confirmation audio file may be played after the user has begun to input data into a subsequent data field (e.g., a data field 35). After the VIN has been input into the data field 25 and the data field 35 is highlighted, the confirmation audio file may output, “Is the data in the previous field correct?” and/or “The data is successfully entered.” The retry audio file (e.g., audio file 45) may be played when the input data is unsuccessfully obtained/entered. For example, an audio file 40 is linked to the data field 35 and instructs the user to scan a bar code on the customer's license. If the scan is unsuccessful, the audio file 45 may be played. Thus, the data field may be linked to more than one audio file, e.g., an instruction audio file (type of data, where to locate data, etc.), a retry audio file, a confirmation audio file, etc., and the audio files may be output based on corresponding predetermined events.

When the data collected by the application 10 is ready to be submitted to the central computer 310, a submit button 50 may be highlighted, and an audio file 55 linked with the submit button 50 may be played. In another exemplary embodiment, when data has been entered into all of the data fields (or required data fields—e.g., a customer's email address data field may not require input data to be ready for submission), the audio file 55 is played, indicating that the data is ready for submission. A confirmation audio file may also be linked with the submit button 50 so that the employee knows that the data has been received by the central computer 310. A retry audio file may also be linked to the submit button 50. Thus, if the data is submitted without the input data in one of the (required) data fields, the audio file corresponding to the data field is played, reminding the user to enter the input data.

The application 10 may further utilize an exit audio file 60 which is played when the application 10 is terminated. For example, when the mobile device 5 is going to be used for another purpose, the exit audio file 60 may be played. Thus, the employee can audibly confirm that the mobile device 5 is ready to be used for a different application.

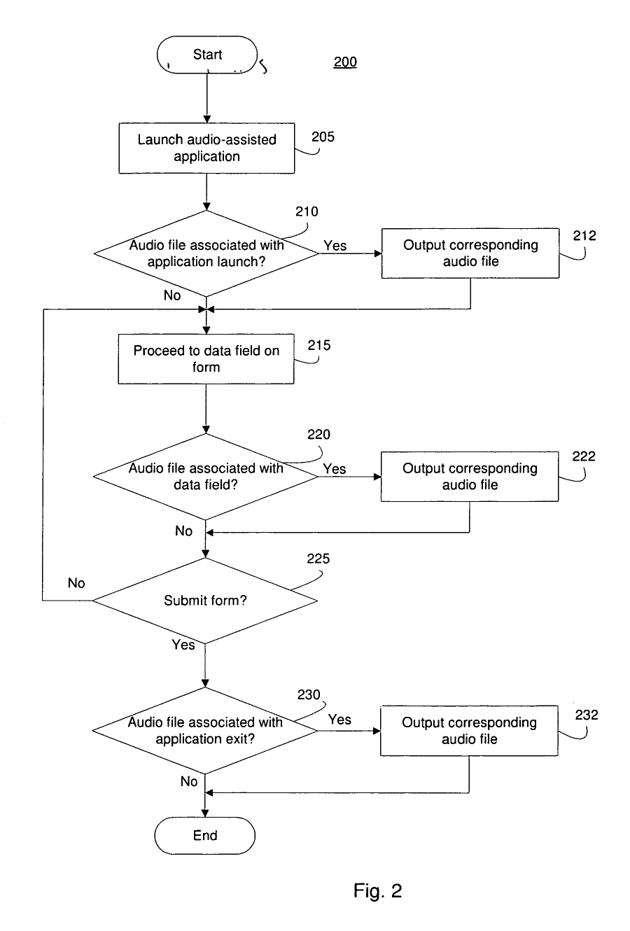

FIG. 2 shows an exemplary embodiment of a method 200 for using a media-assisted application according to the present invention. In step 205, the application 10 is launched and displayed on the display screen 9. In step 210, it is determined whether an audio file is associated with the launching of the application 10. If so, the audio file 20 is output (step 212). As noted above, the audio file 20 may be output when the application is running and/or when the mobile device 5 switches from the power-save mode to the wake mode. In addition, the audio file 20 may be repeated by, for example, pressing a preselected button on the mobile device 5. A repeat feature may be utilized for any audio file output during use of the application 10.

In step 215, the application 10 proceeds to (e.g., highlights) a data field on the application 10. The application 10 highlights the data field immediately after the audio file 20 is output or when a user of the mobile device 5 manually highlights the data field or enters data thereinto. In step 220, the application 10 determines whether an audio file is associated with the highlighted data field (e.g., by referencing the table 400). The application 10 then selects and outputs the corresponding audio file, as shown in step 222.

In step 225, the application 10 determines whether the form is to be submitted. If not, the application 10 proceeds through remaining data fields on the form (or those highlighted by the user) and outputs the audio files corresponding thereto, until the form is submitted. When the form is submitted to the central computer 310, the application 10 may output a corresponding audio file (e.g., confirmation audio file). In step 230, the application 10 is exited and plays the exit audio file 60 (step 232).

In another exemplary embodiment, the present invention provides a software development platform for generating a media-assisted application. In this embodiment, the platform provides a form, a plurality of data fields and a plurality of audio files. An application developer inserts the data fields into the form (along with any text and/or images) to generate a visual representation of the application (e.g., the application 10 shown in FIG. 1). The developer may then associate one or more the audio files with corresponding data fields and/or predetermined events encountered during use of the application. For example, the audio file 20 may be associated with the launch of the application on a computing device, and the audio file 30 may be associated with the data field 25. In the exemplary embodiment, the platform provide a what-you-see-is-what-you-get (WYSIWYG) environment so that the developer can simply drag-and-drop the data fields and the audio files into the form, and the platform generates the corresponding software code for implementing the application.

Those of skill in the art will understand that the audio-assisted application provides several advantages. For example, in poor lighting conditions such as low-light and glare, the audio-assisted application guides the user through content presented on the display screen of the mobile device. These benefits are also realized by users with impaired sight or who are required to wear safety eyewear. The audio-assisted application also benefits user which are new to the application and/or when the audio assisted application is used in self-service modalities.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
an audio output arrangement;
a display screen displaying a plurality of data fields;
a memory storing a plurality of audio files, at least one of the audio files being associated with a corresponding one of the data fields; and
a processor outputting the at least one of the audio files via the audio output arrangement to request an entry of data into the corresponding data field.

2. The device according to claim 1, wherein the device includes at least one of a laser-based scanner, an imager-based scanner, an RFID reader, a PDA, a mobile phone, a digital camera, a magnetic stripe reader and a digital media player.

3. The device according to claim 1, wherein the audio output arrangement is one of a speaker and a headset.

4. The device according to claim 1, wherein the audio files include at least one of instructions, usage tips, guidelines, help messages and foreign language translations.

5. The device according to claim 1, further comprising:
a wireless communications arrangement wirelessly transmitting data entered into the plurality of data fields to a computing device.

6. A method, comprising:
launching an application on a computing device, the application including a plurality of data fields displayed on a display screen of the computing device;
outputting a first audio file on an audio output arrangement of the computing device, the first audio file corresponding to the launched application;
selecting a data field on the display screen; and
outputting a second audio file on the audio output arrangement corresponding to the selected data field.

7. The method according to claim 6, wherein the computing device includes at least one of a laser-based scanner, an imager-based scanner, an RFID reader, a kiosk, a laptop, a PDA, a mobile phone, a laptop, a digital camera, a magnetic stripe reader and a digital media player.

8. The method according to claim 6, wherein the first audio file is a title of the application.

9. The method according to claim 6, wherein the audio output arrangement is one of a speaker and a headset.

10. The method according to claim 6, wherein the second audio file includes at least one of (i) a request for entry of data into the selected data field, (ii) an instruction for how to enter data into the selected field, (iii) a description of a type of data which should be entered into the selected data field.

11. The method according to claim 6, further comprising:
outputting a confirmation audio file when data has been properly received within the selected data field.

12. The method according to claim 6, further comprising:
when the data entered into the selected data field is incomplete, outputting a retry audio file.

13. The method according to claim 6, further comprising:
upon terminating the application, outputting a third audio file indicative of a termination of the application.

14. The method according to claim 6, wherein the selecting step includes one of the following substeps:
highlighting the selected data field;
detecting a user action corresponding to a selection of the selected data field.

15. The method according to claim 6, further comprising:
prompting a user to enter data into the selected data field.

16. A computer-readable storage medium storing a set of instructions, the set of instructions capable of being executed by a processor, the set of instructions performing the steps of:
displaying a plurality of data fields on a display screen of the computing device;
outputting a first audio file on an audio output arrangement of the computing device, the first audio file corresponding to the application;
selecting a data field on the display screen; and
outputting a second audio file on the audio output
arrangement corresponding to the selected data field.

17. The computer-readable storage medium according to claim 16, wherein the second audio file includes at least one of (i) a request for entry of data into the selected data field, (ii) an instruction for how to enter data into the selected field, (iii) a description of a type of data which should be entered into the selected data field.

18. The computer-readable storage medium according to claim 16, wherein the selecting step includes one of the following substeps:
highlighting the selected data field;
detecting a user action corresponding to a selection of the selected data field.

19. The computer-readable storage medium according to claim 16, further comprising:
prompting a user to enter data into the selected data field.

20. An software development platform for building an audio-assisted application, comprising:
a form;
a plurality of data fields being insertable into the form; and
a plurality of audio files, selected ones of the audio files being associated with corresponding ones of the data fields,
wherein, when the application detects a predetermined input related to a particular data field, a corresponding audio file associated with the data field is output.

21. The software development platform according to claim 20, wherein the form provides a graphical user interface for the application.

22. The software development platform according to claim 20, wherein the predetermined input is at least one of (i) a launch of the application and (ii) a selection of the particular data field.

23. The software development platform according to claim 20, wherein the audio files include at least one of instructions, usage tips, guidelines, help messages and foreign language translations.

24. A device, comprising:
an audio output means;
a display means for displaying a plurality of data fields;
a storage means for storing a plurality of audio files, at least one of the audio files being associated with a corresponding one of the data fields; and
a means processor outputting the at least one of the audio files via the audio output arrangement to request an entry of data into the corresponding data field.
